(19) United States
(12) Patent Application Publication
(10) Pub. No.: US 2019/0280634 A1
(43) Pub. Date: Sep. 12, 2019

(54) MOTOR CONTROL DEVICE AND PROGRAM

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Hiroshi OTA, Misato Saitama (JP); Hirofumi OMOTE, Adachi Tokyo (JP); Hitoshi SAITO, Yokohama Kanagawa (JP)

(21) Appl. No.: 16/117,788

(22) Filed: Aug. 30, 2018

(30) Foreign Application Priority Data
Mar. 8, 2018 (JP) 2018-041558

(51) Int. Cl. H02P 23/00; H02P 5/74

(52) U.S. Cl. CPC H02P 23/0077; B64C 39/024; H02P 5/74

(57) ABSTRACT

A motor control device includes a processor configured to receive a first signal and a second signal, and determine a second command value, based on a first value of a first signal in which a characteristic of a waveform based on a first command value is present and a second value of a second signal representing data of the first command value, and a motor control unit configured to control a motor based on the second command value.

### CROSS-REFERENCE TO RELATED APPLICATIONS

This application is based upon and claims the benefit of priority from Japanese Patent Application No. 2018-041558, filed Mar. 8, 2018, the entire contents of which are incorporated herein by reference.

### FIELD

Embodiments described herein relate generally to a motor control device and a program.

### BACKGROUND

In the related art, a motor control device is known that is communicable with a main control device and controls a motor based on a rotation speed command received from the main control device.

### DESCRIPTION OF THE DRAWINGS

FIG. 1 is a schematic and exemplary block diagram of a motor system according to an embodiment.

FIG. 2 is a schematic and exemplary block diagram of a motor control device according to the embodiment.

FIG. 3 is a schematic and exemplary flowchart illustrating a sequence of processing performed in the motor control device according to the embodiment.

FIG. 4 is a schematic and exemplary perspective view of a drone as the motor system according to the embodiment.

### DETAILED DESCRIPTION

Embodiments provide a motor control device which is beneficial, if the motor control device having a new configuration with less abnormality is obtained.

In general, according to one embodiment, a motor control device includes a processor configured to receive a first signal and a second signal, and determine a second command value, based on a first value of a first signal in which a characteristic of a waveform based on a first command value is present and a second value of a second signal representing data of the first command value, and a motor control unit configured to control a motor based on the second command value.

Hereinafter, embodiments of a motor control device and a motor system including the motor control device are disclosed. Configurations and control (technical features) of the embodiments illustrated below are mere examples. In addition, in the present specification, ordinal numbers are used only for distinguishing a signal, a value, a configuration element, and the like, and do not intend to represent the order of priority and order.

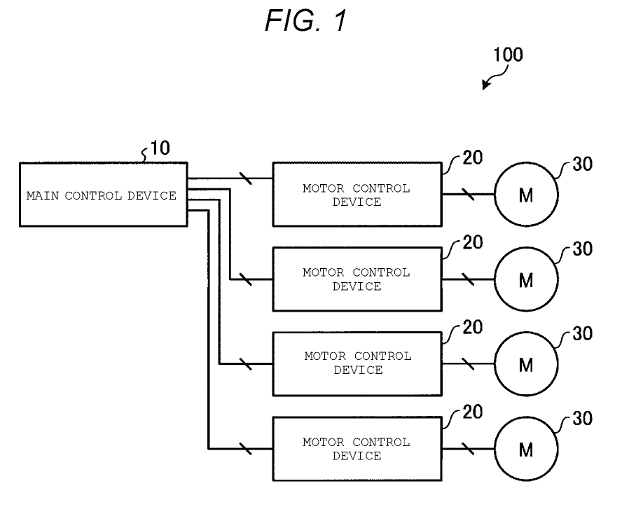

FIG. 1 is a block diagram of a motor system 100. As illustrated in FIG. 1, the motor system 100 includes a main control device 10, a plurality of motor control devices 20, and a plurality of motors 30.

The main control device 10, e.g., a controller circuit, is configured to be communicable with the respective motor control devices 20. The main control device 10 transmits a signal representing a command value (first command value) of a rotation speed or a rotation direction of a shaft of the motor 30 to the respective motor control devices 20. The first command value may also be referred to as a transmission command value.

The motor control device 20 determines a command value (second command value) from a value (reception value) obtained by demodulating or decoding a signal received from the main control device 10, and controls the motor 30 based on the second command value. The second command value may also be referred to as a control command value or a determination command value. The motor 30 is, for example, a three-phase brushless motor.

Here, in the present embodiment, the main control device 10 transmits a plurality of signals representing first command values in parallel, at each of a plurality of transmission time steps, to at least one of a plurality of motor control devices 20. That is, a multiplex system is configured between the main control device 10 and the motor control device 20 with regard to communication, particularly transmission of a signal representing the first command value. Treating the plurality of signals representing the first command value transmitted in parallel in the motor control device 20 will be described below.

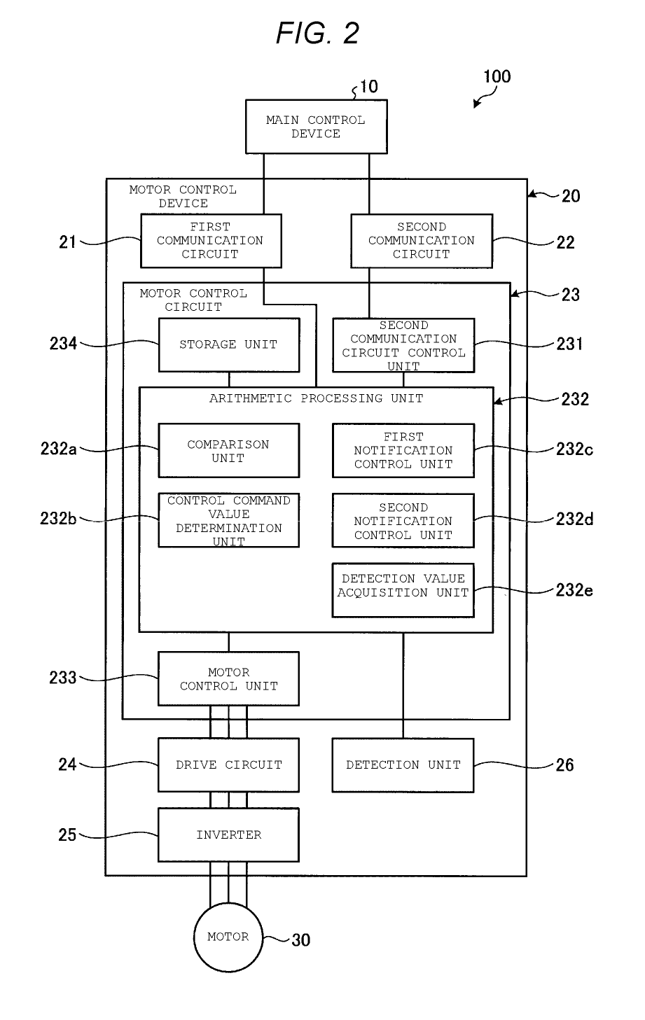

FIG. 2 is a block diagram of the motor control device 20. As illustrated in FIG. 2, the multiplex system is configured between the main control device 10 and the motor control device 20 with respect to transmission of a signal representing the first command value.

The motor control device 20 includes a first communication circuit 21, a second communication circuit 22, a motor control circuit 23, a drive circuit 24, an inverter 25, and a detection unit 26, e.g., a sensor.

During each time step, the main control device 10 transmits a first signal and a second based on one of the first command values for a motor 30 to the motor control device 20 in parallel with a first signal or a second signal. The first signal and the second signal are transmitted through communication methods (a communication protocol, a hardware configuration) different from each other and in parallel with each other.

The first signal has a characteristic of a waveform that changes depending on the first command value for the motor 30. The first signal is, for example, a pulse width modulation (PWM) signal. In this case, the first signal is a pulse signal that is output at a predetermined cycle and is set such that the larger the pulse width (a duty ratio, high level (H) has longer time) is, the higher the command value is. For example, in a case where the first command value represents a rotation speed, the larger the pulse width, the higher the rotation speed of the command value. The relationship between the first command value and the pulse width is linear. Such an example is an example of a characteristic of a waveform in which the pulse width changes depending on the first command value.

The first communication circuit 21 receives the first signal and acquires the first value (first reception value) represented by the first signal. For example, the first communication circuit 21 acquires a count value corresponding to a time interval exceeding a predetermined threshold, and acquires a first value corresponding to the count value. The higher the count value, the longer the signal and thus the larger the first value. The first communication circuit 21 transmits the acquired first value to an arithmetic processing unit 232 of the motor control circuit 23.

The second signal is a digital signal representing data of the first command value. The second signal is, for example, a controller area network (CAN) signal.

The second communication circuit 22 and a second communication circuit control unit 231 receive the second signal and acquire a second value (second reception value) represented by the second signal. In this case, the second communication circuit 22 converts a differential signal of CAN-H and CAN-L into a serial signal (reception signal), and the second communication circuit control unit 231 acquires the second value from the serial signal. The second communication circuit 22 is, for example, a CAN transceiver, and the second communication circuit control unit 231 is, for example, a CAN controller.

The second communication circuit 22 and the second communication circuit control unit 231 can transmit a signal (a first notification signal, a second notification signal) for notifying the main control device 10 of information. In this case, the second communication circuit control unit 231 generates a serial signal (transmission signal) representing information to be transmitted, and the second communication circuit 22 converts a serial signal into the differential signal of CAN-H and CAN-L (the first notification signal, the second notification signal). The second communication circuit 22 and the second communication circuit control unit 231 are examples of a communication unit. The information notified to the main control device 10 will be described below.

The motor control circuit 23 includes an arithmetic processing unit 232, a motor control unit 233, and a storage unit 234 in addition to the second communication circuit control unit 231. The motor control circuit 23 is, for example, a micro control unit (MCU).

The arithmetic processing unit 232 includes a comparison unit 232a, a control command value determination unit 232b, a first notification control unit 232c, a second notification control unit 232d, and a detection value acquisition unit 232e. The arithmetic processing unit 232 is, for example, a micro processing unit (MPU).

The comparison unit 232a compares the first value acquired from the first signal with the second value acquired from the second signal. The control command value determination unit 232b determines the second command value, based on the comparison result between the first value and the second value obtained by the comparison unit 232a.

The main control device 10 generates the first signal and the second signal, based on one of the first command values for the motor 30 at each time step. Thus, the first value and the second value acquired at corresponding timing, in other words, the first value and the second value obtained from the first signal and the second signal generated corresponding to the same first command value of the main control device 10 ideally have the same value. However, there is a possibility that a difference between reception states of the first signal and the second signal may occur, or a difference between the first value and the second value may occur due to failure of a device, introduction of noise, accuracy of modulation or demodulation, and the like. Therefore, the control command value determination unit 232b can determine the second command value as follows.

Case (1) in a Case where the Difference (Absolute Value) Between the First Value and the Second Value is Equal to or Less than a Predetermined Value (a First Threshold)

In case (1), the control command value determination unit 232b determines that one of the first value and the second value is the second command value at a current time step. In addition, in this case, the control command value determination unit 232b can determine, for example, the second value as the second command value. Generally, this is because the CAN signal is more unlikely to be affected by noise or the like than a PWM signal, and thus its reliability is higher in many cases.

Case (2) in a Case where the Difference (Absolute Value of the Difference) Between the First Value and the Second Value is Larger than the Predetermined Value (the First Threshold Value)

In case (2), the control command value determination unit 232b determines, for example, a value closer to the second command value at an immediately preceding time step among the first value and the second value, that is, a value with a smaller absolute value of a difference with the second command value at the immediately preceding time step, as the second command value at a current time step. However, in this case, if the difference between the first value or the second value and the second command value at the preceding time step is equal to or larger than a second predetermined value (the second threshold), the control command value determination unit 232b may determine the second command value at the preceding time step as the second command value at the current time step. The second threshold is larger than the first threshold.

Case (3) in a Case where the First Signal is Received (with the First Value) and the Second Signal is not Received (without the Second Value), or Case (4) in a Case where the First Signal is not Received (without the First Value) and the Second Signal is Received (with the Second Value).

In cases (3) or (4), if the difference between the first value or the second value and the second command value at the preceding time step is equal to or less than the predetermined value (the second threshold), the obtained first value (in the case of (3)) or the obtained second value (in the case of (4)) can be determined as the correct command value. Meanwhile, if the difference between the first value or the second value and the second command value at the preceding time step is larger than the second predetermined value (the second threshold), the second command value at the preceding time step can be determined as the correct command value at the current time step.

Case (5) in a Case where One of the First Value and the Second Value from the Main Control Device 10 is Instructed to be, i.e., Designated as, the Second Command Value

In case (5), the motor control unit 233 determines one of the first value and the second value as the second command value, according to the instruction, in other words, the instruction information for designating one of the first value and the second value from the main control device 10. The arithmetic processing unit 232 can receive an instruction signal representing the instruction information via, for example, the second communication circuit 22 and the second communication circuit control unit 231.

In a case where one of the first signal and the second signal cannot be received, in other words, in a case where one of the first value and the second value is obtained and the other cannot be obtained (the case of (3) or (4)), or in a case where the difference between the first value and the second value is larger than the predetermined value (the first threshold), that is, in the case of (2) described above, the first notification control unit 232c generates first notification information. The first notification information includes, for example, information indicating a signal (first signal or second signal) is not received, at least one of the first value and the second value obtained from the received signal, information indicating the time when the event of (2), (3), or (4) occurs, other information, and the like. The first notification control unit 232c controls the second communication circuit control unit 231 and moreover the second communication circuit 22 so as to transmit the first notification signal representing the first notification information.

The second notification control unit 232d generates second notification information. The second notification information is information for notifying other devices such as the main control device 10 of a detection value obtained by the detection value acquisition unit 232e. For example, the second notification information may include information indicating the detection value, information indicating detection time of the detection value, other information, and the like. The second notification control unit 232d can generate the second notification information at a predetermined time such as time with a fixed time interval, regardless of reception states of the first signal and the second signal, a difference between the first value and the second value, and the like. The second notification control unit 232d controls the second communication circuit control unit 231 and moreover the second communication circuit 22 so as to transmit the second notification signal representing the second notification information.

The detection value acquisition unit 232e acquires a detection value from a detection signal of the detection unit 26.

The motor control unit 233 transmits a control signal to the drive circuit 24 such that the motor 30 is controlled by the second command value determined by the control command value determination unit 232b. The motor control unit 233 is, for example, a vector control circuit, but is not limited thereto, and may be a V/f control circuit or the like.

The motor control circuit 23 includes a main storage unit such as a read only memory (ROM) or a random access memory (RAM), and an auxiliary storage unit such as a solid state drive (SSD) or a flash memory, as the storage unit 234.

The arithmetic processing unit 232 reads and executes a program (application) stored in the ROM, the SSD, the flash memory or the like. The arithmetic processing unit 232 operates according to the program, thereby, functioning as each unit in the arithmetic processing unit 232, that is, the comparison unit 232a, the control command value determination unit 232b, the first notification control unit 232c, the second notification control unit 232d, the detection value acquisition unit 232e, and the like. In this case, the program includes modules corresponding to the respective units described above.

The program may be recorded in a computer-readable recording medium (storage medium) such as a CD-ROM, a FD, a CD-R, a DVD, or a USB memory as a file of an installable format or an executable format. In addition, the program may be stored in a storage unit of a computer connected to a communication network and may be introduced by being downloaded via the network. In addition, the program may be stored in the ROM or the like in advance.

In a case where all or part of the arithmetic processing unit 232 is implemented by hardware, the arithmetic processing unit 232 may include, for example, a field programmable gate array (FPGA), an application specific integrated circuit (ASIC), or the like.

The drive circuit 24 controls on and off of switching elements (not illustrated) of each phase included in the inverter circuit 25, based on a control signal obtained from the motor control unit 233. The switching element is, for example, a metal-oxide-semiconductor field effect transistor (MOS-FET), an insulated gate bipolar transistor (IGBT), or the like. The drive circuit 24 may be referred to as a gate driver.

The inverter circuit 25 generates a three-phase alternating current from a direct current by switching the switching elements on and off using the drive circuit 24. The inverter circuit 25 includes a plurality of switching elements (not illustrated) bridge-connected for each phase. Power applied to windings of each phase of the motor 30 from a power source (not illustrated) is changed by switching the switching elements on and off. The three phases of the motor 30 are connected by a Y connection (star connection), a Δ connection, or the like. Each winding of the motor 30 may be connected to a power amplification circuit or the like.

In addition, the motor control circuit 23 can include, for example, a sensor that detects current values of each phase of the motor 30, a rotation sensor that detects a rotation speed of the motor 30, a temperature sensor, and the like, as the detection unit 26.

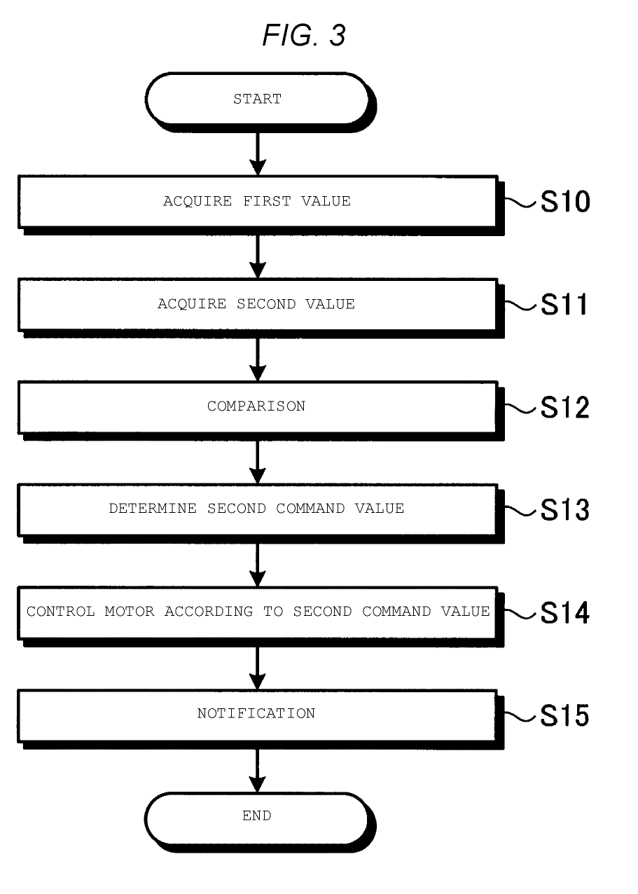

FIG. 3 is a flowchart illustrating a sequence of processing performed by the motor control device 20.

As illustrated in FIG. 3, the arithmetic processing unit 232 acquires a first value obtained from a first signal, from the first communication circuit 21 (S10), and acquires a second value obtained from a second signal, from the second communication circuit control unit 231 (S11). Sequences of S10 and S11 may be exchanged.

Next, the arithmetic processing unit 232 functions as the comparison unit 232a, and compares the first value with the second value (S12).

Next, the arithmetic processing unit 232 functions as the control command value determination unit 232b, and determines a second command value, according to the cases (1) to (5) described above. In a case where the first value is not obtained in S10 and the second value is not obtained in S11, the second command value can be determined such that the motor 30 stops (S13).

Next, the motor control unit 233 controls the drive circuit 24 and moreover the inverter circuit 25 such that the motor 30 reaches a rotation speed of the second command value (S14).

Next, the arithmetic processing unit 232 functions as the second notification control unit 232d, and generates the second notification information for notifying another device such as the main control device 10 of the second notification information at a predetermined time step. In addition, in a case where the events (2), (3), and (4) occur, the arithmetic processing unit 232 functions as the first notification control unit 232c and generates the second notification information for notifying another device such as the main control device 10 of the first notification information. In addition, in this case, the second communication circuit control unit 231 and the second communication circuit 22 transmit the first notification signal for notifying the first notification information to another device and transmit the second notification signal for notifying the second notification information to another device (S15).

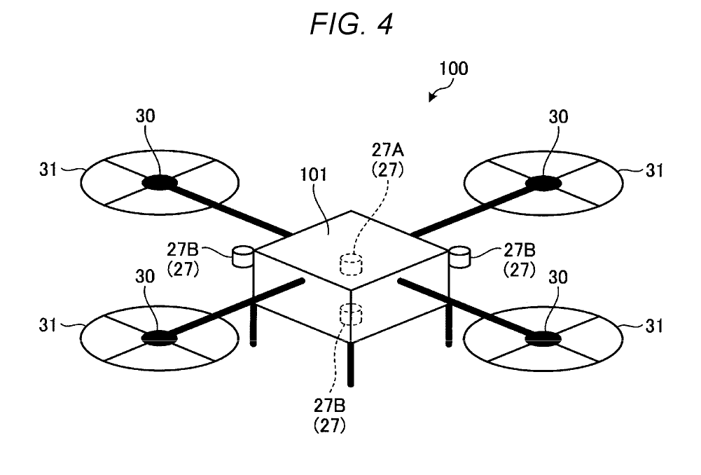

FIG. 4 is a perspective view of a drone in a case where the motor system 100 is configured as a drone. The motor system 100 (drone) includes a body 101, a plurality of (for example, four) blades or propellers 31, and a plurality of (for example, four) motors 30 rotating the respective propellers 31. The body 101 is provided with an inertia measurement device 27A that detects a posture of the body 101 (the motor system 100) and a plurality of cameras 27B, as the detection unit 27. The main control device 10 can determine a first command value, based on a detection value of the detection unit 27 and can control the respective motors 30.

As described above, the control command value determination unit 232b of the motor control device 20 according to the present embodiment determines the second command value, based on the first value obtained from the first signal and the second value obtained from the second signal. The first signal has a characteristic of a waveform that changes according to the first command value of the motor 30, and the second signal represents data of the first command value. According to the configuration, a multiplex system is configured for transmission of the signal representing the first command value, and thus, it is possible to achieve the motor system 100 with higher robustness, higher redundancy, or a failsafe function.

In addition, in a case where one of the first signal and the second signal cannot be received, in other words, in a case where one of the first value and the second value is not obtained, the motor control device 20 includes the first notification control unit 232c that controls the second communication circuit 22 and the second communication circuit control unit 231 (communication unit) such that the first notification signal is transmitted. According to the configuration, for example, the main control device 10 can continue control of the motor 30 performed by the motor control device 20 by transmitting an instruction signal representing instruction information for setting one of the first value and the second value to the motor control device 20 as the second command value, depending on a reception state of the first signal and the second signal of the motor control device 20, based on the first notification information obtained from the first notification signal. In addition, the main control device 10 can control another motor 20 such that the drone can stably fly by adjusting the output of the other motor 30 when the output of the motor 30 is reduced, based on the first notification information obtained from the first notification signal. That is, according to the configuration, it is possible to realize the motor system 100 with higher robustness.

In addition, the motor control device 20 includes the second notification control unit 232d that controls the second communication circuit 22 and the second communication circuit control unit 231 (communication unit) such that the second notification signal representing the detection value obtained by the detection unit 26 is transmitted. According to the configuration, for example, the main control device 10 can perform a failure prediction calculation or the like, based on the second notification information obtained from the second notification signal.

Although embodiments are exemplified above, the embodiments are merely examples, and it is not intended to limit the scope of the disclosure. The embodiments can be implemented in various other forms, and various omissions, substitutions, combinations, and modifications can be made without departing from the spirit of the disclosure. The embodiments are included in the scope and gist of the disclosure and are included in the invention described in the scope of claims and the equivalent scope thereof. In addition, the configuration and shape of the embodiment can also be partly exchanged. In addition, the specifications (structure, type, a direction, format, size, length, width, thickness, height, angle, number, arrangement, position, material, and the like) of each configuration and shape can be changed as appropriate.

For example, the number of motors and motor control devices is not limited to four. In addition, the motor system can be configured as a system or device different from the drone. In addition, the characteristic of the waveform that changes according to the first command value is not limited to a pulse width (duty ratio). In addition, the motor control device may include, for example, a communication unit different from the second communication circuit and the second communication circuit control unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A motor control device comprising:
a processor configured to receive a first signal and a second signal, and determine a second command value, based on a first value of a first signal in which a characteristic of a waveform based on a first command value is present and a second value of a second signal representing data of the first command value; and
a motor control unit configured to control a motor based on the second command value.

2. The motor control device according to claim 1, wherein the processor is further configured to:
control a communication circuit to transmit a first notification signal in the event that one of the first value and the second value is not received by the processor.

3. The motor control device according to claim 2, further comprising:
a sensor, wherein
the processor is further configured to control the communication unit to transmit the second notification signal representing a detection value of the sensor.

4. The motor control device according to claim 1, wherein the first signal is a pulse wave modulation signal.

5. The motor control device according to claim 1, wherein the second signal is a controller area network (CAN) signal.

6. The motor control device of claim 1, wherein the first value relates to one of a motor shaft speed and a motor shaft rotation direction.

7. A motor system, comprising:
a main control circuit configured to transmit a first signal and a second signal indicative of a value of a first motor control command;
a motor control circuit configured to receive the first signal and the second signal, and derive therefrom a value of a second motor control command; and
at least one motor having a shaft, wherein
the first and second signals are different types of signals, and each is related to a same one of a rotation speed and rotation direction of the shaft.

8. The motor system according to claim 7, wherein the first signal is a pulse wave modulation signal, the duration of which is related to the value of the first motor control command.

9. The motor system according to claim 8, wherein the second signal is a controller area network (CAN) signal.

10. The motor system according to claim 8, wherein the motor control circuit is further configured to:
determine a value of the first motor control command from the first signal;
determine a value of the first motor control command from the second signal; and
set the second motor control command using the values of the first motor control command determined from the first signal and the second signal.

11. The motor system according to claim 10, wherein the motor control circuit is further configured to determine the absolute value of a difference between the value of the first motor control command determined from the first signal and the value of the first motor control command determined from the second signal; and
compare the absolute value of the difference to a first threshold value.

12. The motor system of claim 11, wherein the motor control circuit is further configured to use one the values of the first motor control command determined from the first signal and the second signal as the value of the second motor control command if the absolute value of the difference is less than or equal to the first threshold value.

13. The motor system of claim 11, wherein the motor control command device is further configured to:
determine a prior value of the second motor control command if the difference in the value of the first motor control command determined from the first signal and the value of the first motor control command determined from the second signal is greater than or equal to the threshold value, and
set the value of the second motor control command to the one of the value of the first motor control command determined from the first and the value of the first motor control command determined from the second signal that is closest to the prior value of the second motor control command.

14. The motor system of claim 13, wherein the motor control circuit is further configured to set the value of the second motor control command as the prior value if the difference in the value of the first motor control command determined from the first signal and the value of the first motor control command determined from the second signal is greater than or equal to a second threshold value, which is greater than the first threshold value.

15. A non-transitory computer readable medium comprising instructions executable in a processor, wherein the processor executing the instructions carries out the steps of:
comparing a first value, which is obtained from a first signal in which a characteristic of a waveform based on a first command value, with a second value, which is obtained from a second signal representing data of the first command value; and
determining a second command value based on a comparison result which is obtained by comparing the first value with the second value.

16. The non-transitory computer readable medium of claim 15, wherein the processor executing the instructions further carries out the steps of:
determining the absolute value of a difference in the first and second values to obtain the comparison result; and
comparing the comparison result to a first threshold value.

17. The non-transitory computer readable medium of claim 16, wherein the processor executing the instructions further carries out the steps of:
setting the second command value as one of the first value and the second value where the determination result is less than the first threshold value.

18. The non-transitory computer readable medium of claim 16, wherein, if the determination result is greater than the first threshold, the processor executing the instructions further carries out the steps of:
comparing the comparison result to a second threshold value greater than the first threshold value, and if the comparison result is less than the second threshold value;
determining a prior second command value; and
setting the value of the second command value as the one of the first value and the second value closest to the prior second command value.

19. The non-transitory computer readable medium of claim 16, wherein, if the determination result is greater than the first threshold, the processor executing the instructions further carries out the steps of:
comparing the comparison result to a second threshold value greater than the first threshold value, and if the comparison result is greater than the second threshold value;
determining a prior second command value; and
setting the value of the second command value to the prior second command value.
